(19) United States
(12) Patent Application Publication
(10) Pub. No.: US 2012/0173847 A1
(43) Pub. Date: Jul. 5, 2012

(54) PARALLEL PROCESSOR AND METHOD FOR THREAD PROCESSING THEREOF

(76) Inventors: Simon Moy, Mountain View, CA (US); Shihao Wang, Shenzhen (CN); Wing Yee Lo, Shenzhen (CN)

(21) Appl. No.: 13/395,694

(22) PCT Filed: Nov. 5, 2009
(86) PCT No.: PCT/CN2009/074826

§ 371 Date: Mar. 13, 2012

(30) Foreign Application Priority Data
Sep. 18, 2009 (CN) 200910190339.1

(51) Int. Cl. G06F 9/38

(52) U.S. Cl. 712/32; 712/E09.045

(57) ABSTRACT

A parallel processor and a method for concurrently processing threads in the parallel processor are disclosed. The parallel processor comprises: a plurality of thread processing engines for processing threads distributed to the thread processing engines, and the plurality of thread processing engines being connected in parallel; a thread management unit for obtaining, judging the statuses of the plurality of thread processing engines, and distributing the threads in a waiting queue among the plurality of thread processing engines.

### TECHNICAL FIELD OF THE INVENTION

The present invention relates to the field of multi-thread processing, and in particular to a parallel processor and a method for thread processing thereof.

### BACKGROUND OF THE INVENTION

The development of electronic technology has a higher and higher demand on processor; generally, an integrated circuit engineer provides more or better performances for users by increasing clock speed, adding hardware resource and special application function; however, this practice is not suitable in some application occasions, particularly in mobile applications. Generally, the increase of the raw speed of processor clock can not break the bottleneck of the processor caused by the limit of peripheral speed and access memory. For the processor, the addition of hardware requires higher use efficiency of lots of processors in use; due to lack of instruction level parallelism (ILP), the addition of hardware mentioned above is generally impossible. However, the adoption of special function module would limit the application scope of the processor and delay the product time-to-market; especially for the processor needing to provide parallel processing, the problems above are more obvious; although improving the hardware performance alone, for example, increasing the clock frequency and increasing the kernel number in processor, to some extent can solve the problems above, the cost and power consumption might be increased, thus the cost is too high and the cost performance is not high.

### SUMMARY OF THE INVENTION

In view of the defects in the prior art that the cost and power consumption are increased, the cost is too high and the cost performance is not high, the technical problem to be solved by the present invention is to provide a parallel processor and a method for thread processing thereof with high cost performance.

The technical scheme applied by the present invention to solve the technical problem is to: construct a parallel processor, which comprises:

a plurality of thread processing engines for processing threads distributed to the thread processing engines, the plurality of thread processing engines being connected in parallel;

a thread management unit for obtaining, judging the statuses of the plurality of thread processing engines, and distributing the threads in a waiting queue among the plurality of thread processing engines.

The processor of the present invention further comprises an internal storage system for data and thread buffering and instruction buffering, and a register for storing various statuses of the parallel processor.

In the processor of the present invention, the internal storage system comprises a data and thread buffering unit for buffering the threads and data, and an instruction buffering unit for buffering instructions.

In the processor of the present invention, the plurality of thread processing engines comprises four parallel independent arithmetic logic units (ALU) and multiply-add units (MAC) one-to-one corresponding to the ALUs.

In the processor of the present invention, the thread manager further comprises a thread control register for configuring threads; the thread control register comprises an initial program pointer register for indicating the start physical address of a task program, a local storage area start base point register for indicating the start address of the thread local storage area of a thread, a global storage area start base point register for indicating the start address of the thread global storage area and a thread configuration register for setting the priority and the running mode of the thread.

In the processor of the present invention, the thread manager determines, according to the input data status of a thread and the output buffering capability of the thread, whether to activate the thread; the number of activated threads is greater than the number of the threads running concurrently.

In the processor of the present invention, an activated thread runs on different thread processing engines under the control of the thread manager during different time periods.

In the processor of the present invention, the thread manager changes the thread processing engine on which the activated thread runs by changing the configuration of the thread processing engine; the configuration includes the value of the initial program pointer register.

The processor of the present invention further comprises a thread interrupt unit for interrupting threads by writing data into an interrupt register, wherein the thread interrupt unit controls the interrupt of the threads in the kernel or other kernels when the control bit of the interrupt register is set.

In the processor of the present invention, the thread processing engine, the thread manager and the internal storage system are connected with an external or in-built universal processor and an external storage system via a system bus interface.

The present invention also discloses a method, specifically a method for concurrently processing threads in the parallel processor, comprising the following steps of:

A) configuring a plurality of thread processing engines in the parallel processor;

B) according to the status of the thread processing engine and the status of the to-be-processed thread queue, sending the threads in the to-be-processed thread queue to the thread processing engine;

C) processing the entered threads and enabling them to run by the thread processing engine.

In the method of the present invention, the Step A) further comprises a step of:

A1) judging the type of the to-be-processed thread, configuring the thread processing engine according to the thread type and configuring the local storage area corresponding to the engine.

In the method of the present invention, the Step C) further comprises the steps of:

C1) fetching the instruction of the running thread;

C2) compiling and executing the instruction of the thread.

In the method of the present invention, in the Step C1), the instructions of the thread executed by a thread processing engine are acquired in each period; the plurality of parallel thread processing engines acquires in turn the instructions corresponding to the executed thread.

In the method of the present invention, the to-be-processed thread mode includes data parallel mode, task parallel mode and parallel multi-thread virtual pipelined stream (MVP) mode.

In the method of the present invention, when the running thread mode is parallel MVP mode, the Step C) further comprises a step of: when receiving a software or external interrupt request of a thread, interrupting the thread and executing the preset interrupt program of the thread.

In the method of the present invention, when the running thread mode is parallel MVP mode, the Step C) further comprises a step of: when any running thread needs to wait a long time, releasing the thread processing engine resource occupied by the thread, activating a thread in the to-be-processed thread queue and sending the thread to the thread processing engine.

In the method of the present invention, when the running thread mode is parallel MVP mode, the Step C) further comprises a step of: when the execution of any running thread completes, releasing the thread processing engine resource occupied by the thread and allocating the resource to other running threads.

In the method of the present invention, the threads processed by the thread processing engine are converted by changing the configuration of the thread processing engine; the configuration of the thread processing engine includes the location of the local storage area corresponding to the thread processing engine.

The to-be-processed thread mode includes data parallel mode, task parallel mode and parallel MVP mode.

The implementation of the parallel processor and the method for thread processing thereof of the present invention has the following advantages: since hardware is improved to some extent, a plurality of parallel ALUs and the corresponding storage system in the kernel are used, and the threads to be processed by the processor are managed by a software and thread management unit, so that the plurality of ALUs reaches dynamic load balance when task is saturated, and partial ALUs are shut down when task is not saturated to save power consumption; therefore, high performance can be achieved with a small cost and the cost performance is high.

### BRIEF DESCRIPTION OF THE DRAWINGS

FIG. 1 shows a structure diagram of a processor in an embodiment of the parallel processor and the method for thread processing thereof in the present invention;

FIG. 2 shows a structure diagram of a data thread in the embodiment;

FIG. 3 shows a structure diagram of a task thread in the embodiment;

FIG. 4 shows a structure diagram of an MVP thread in the embodiment;

FIG. 5 shows a structure diagram of an MVP thread in the embodiment;

FIG. 6 shows a structure diagram of MVP thread operation and operation mode in the embodiment;

FIG. 7 shows a structure diagram of MVP thread local storage in the embodiment;

FIG. 8 shows a structure diagram of instruction output in the embodiment;

FIG. 9 shows a diagram of MVP thread buffering configuration in the embodiment; and

FIG. 10 shows a flowchart of thread processing in the embodiment.

### DETAILED DESCRIPTION OF THE INVENTION

The embodiment of the present invention is further illustrated below in conjunction with accompanying drawings.

As shown in FIG. 1, in the embodiment, the parallel processor is a parallel MVP processor, wherein the processor comprises a thread management and control unit 1, an instruction fetch unit 2, an instruction output unit 3, an ALU [3:0] 4, an MAC [3:0] 5, a special function unit 6, a register 7, an instruction buffering unit 8, a data and thread buffering unit 9, a direct memory reading unit 10, a system bus interface 11 and an interrupt controller 12, in which, the thread management and control unit 1 is used for managing and controlling the currently prepared threads, the running threads and so on, and is connected with the system bus interface 11, the instruction fetch unit and the interrupt controller 12 respectively; the instruction fetch unit 2 acquires an instruction through the instruction buffering unit 8 and the system bus interface 11 under the control of the thread management and control unit 1, and outputs the fetched instruction to the instruction output unit 3 under the control of the thread management and control unit 1, meanwhile, the instruction fetch unit 2 is connected with the interrupt controller 12, accepts the control from the interrupt controller 12 when the interrupt controller 12 has an output, and stops fetching instruction; the output of the instruction output unit 3 is connected with the ALU [3:0] 4, the MAC [3:0] 5 and the special function unit 6 via parallel buses, and sends the operation code and operand in the fetched instruction to the four ALUs, the four MACs and the special function unit 6 above respectively according to requirement; the ALU [3:0] 4, the MAC [3:0] 5 and the special function unit 6 also are connected with the register 7 respectively via buses, so as to write the changes of the statuses therein to the register 7 in time; the register 7 is also connected with the ALU [3:0] 4, the MAC [3:0] 5 and the special function unit 6 above respectively (different from the connection above), so as to write the changes of statuses (not caused by the three units above, for example, the status is directly written by software) therein to the three units above; the data and thread buffering unit 9 is connected to the system bus interface 11, acquires data and instruction through the system bus interface 11 and stores the acquired data and instruction for other units (particularly the instruction fetch unit 2) to read; the data and thread buffering unit 9 also is connected with the direct memory reading unit 10, the ALU [3:0] 4 and the register 7 respectively. In the embodiment, a thread processing engine comprises an ALU and an MAC; therefore, in the embodiment, four parallel thread processing engines running on the hardware are included.

In the embodiment, the kernel of the MVP above is implemented by a standard industrial instruction set which is convenient to be converted from intermediate medium by an OpenCL compiler; the implementation channel of the MVP includes four ALUs, four MACs and a 128×32-bit register; in addition, the implementation channel further includes a 64 KB instruction buffering unit, a 32 KB data buffering unit, a 64 KB system random access memory (SRAM) acting as a thread buffer, and a thread management unit.

The MVP can act as an OpenCL device with a software drive layer, and supports two parallel computing modes defined by the OpenCL, namely, data parallel computing mode and task parallel computing mode. When processing the data parallel computing mode, the MVP kernel in one work group at most can process four work items, wherein the four work items are mapped to four parallel threads of the MVP kernel. When processing the task parallel computing mode, the MVP kernel at most can process eight work groups, each work group including one work item, wherein the eight work items also are mapped to eight parallel threads of the MVP kernel; in view of hardware, the task parallel mode has no difference from the data parallel mode. More important, in order to achieve maximum cost performance, the MVP kernel further comprises a dedicated mode, namely, MVP thread mode; in the MVP thread mode, at most eight threads can be configured as the MVP thread mode and the eight threads are presented as a dedicated chip channel hierarchy. In the MVP mode, the eight threads all can be applied to different kernels which are used for stream processing or stream data processing uninterruptedly. Typically, in various stream processing applications, the MVP mode has higher cost performance.

Multi-thread and application thereof are one of the important differences between the MVP and other processors, and can definitely realize a final better solution. In the MVP, the purpose of multi-thread is as follows: providing task parallel and task parallel processing modes defined by OpenCL, and providing a dedicated function parallel mode which is designed for stream channel; adopting load balance to realize maximum hardware resource utilization in the MVP, and reducing the latency hiding capability depending on memory and peripheral speed. In order to discover the advancements of the use of multi-thread and the performance of multi-thread, the MVP removes or reduces excessive special hardware, particularly the hardware set for realizing a special application. Compared with the improvement of hardware performance alone, for example, the improvement of CPU clock rate, the MVP has better generality and flexibility in different applications.

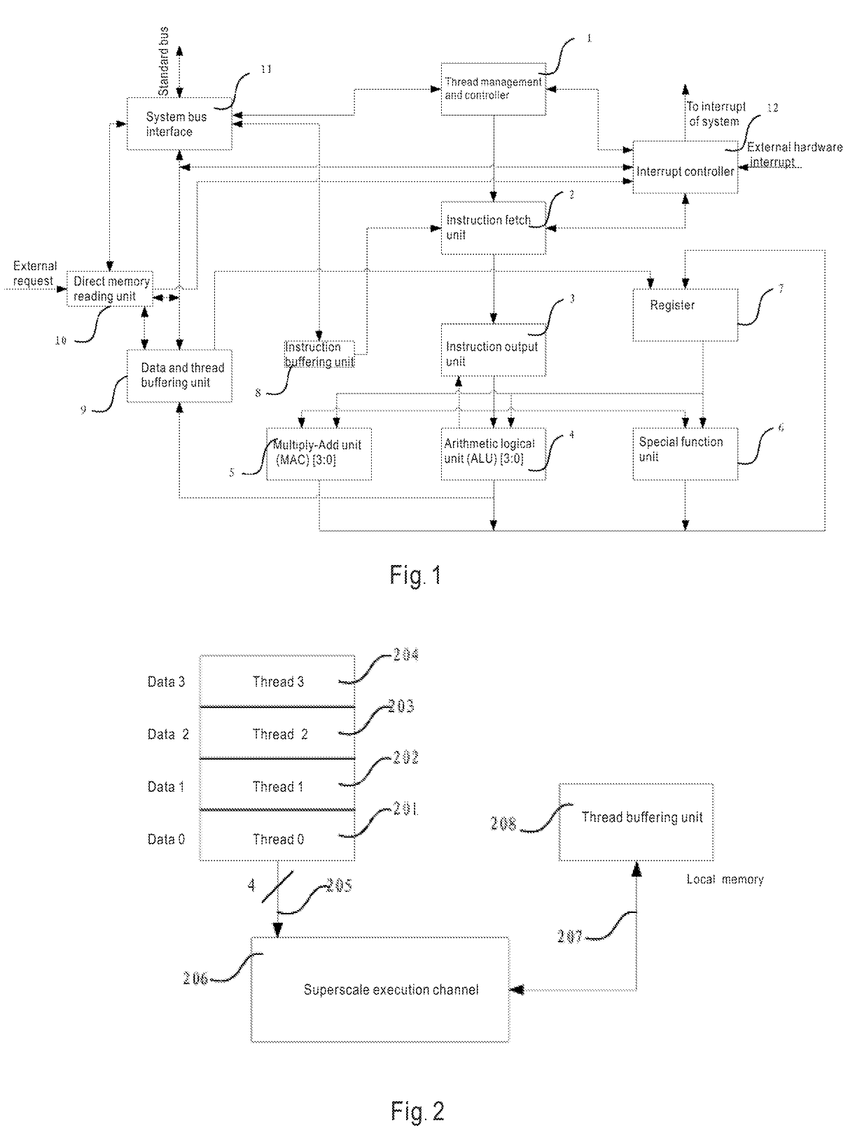

In the embodiment, the MVP supports three different parallel thread modes, including data parallel thread mode, task thread parallel mode and MVP parallel thread mode, in which, the data parallel thread mode is used for processing different stream data passing through the same kernel, for example, the same program in the MVP. (Referring to FIG. 2), data arrives at different time, and the start time of processing is different too. When the threads are running, even if the program which processes them is the same one, the threads are still in different operation flows. In view of MVP instruction channel, there is no difference in the programs with different operations, for example, different tasks. Each data set put to the same thread is a self-contained minimum set, for example, no communication is needed with other data sets, which means that the data thread would not be interrupted for communication with other threads. Each data thread is presented as a work item in OpenCL. FIG. 2 comprises four threads corresponding to data 0 to data 3, namely, thread 0 to thread 4 (201, 202, 203, 204), a superscale execution channel 206, a thread buffering unit 208 (i.e. local memory), a bus 205 connecting the threads (data) with the superscale execution channel 206, a bus 206 connecting the superscale execution channel 206 with the thread buffering unit 208 (i.e. local memory). As mentioned above, in the data parallel mode, the four threads above are the same, and the data thereof is the data of the thread at different time. The essence is that the data input at different time of the same program is processed at the same time. In this mode, the local memory participates in the process above as a whole.

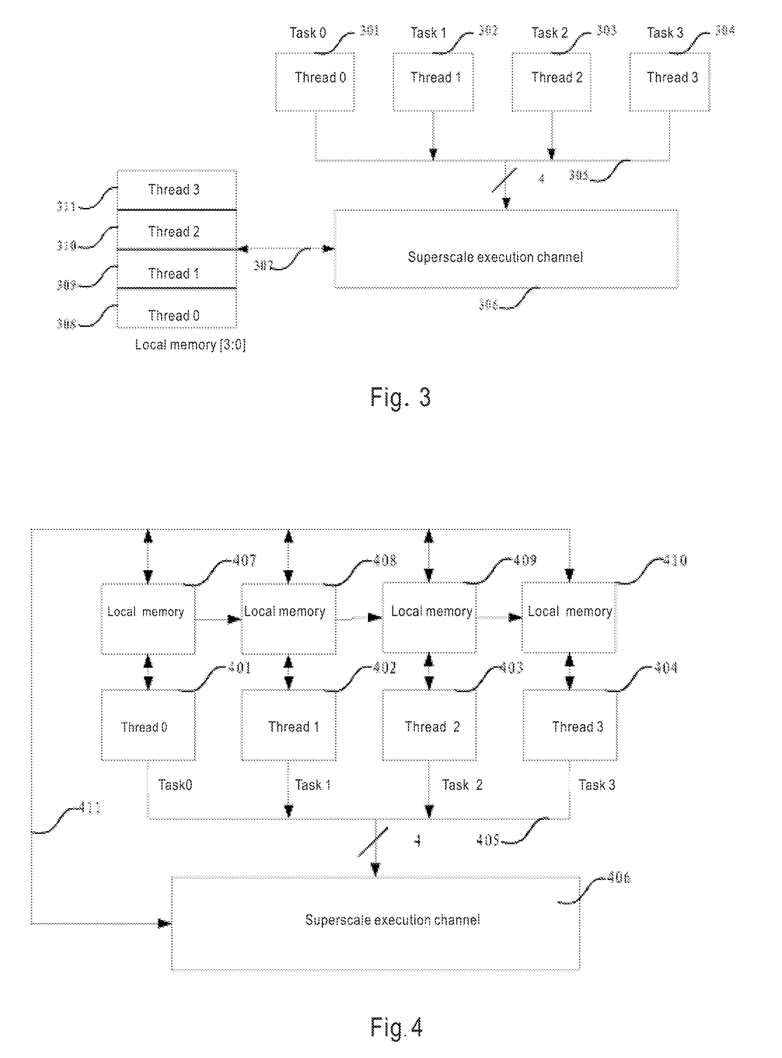

Task threads concurrently run on different kernels. Referring to FIG. 3, in view of operation system, the task threads are presented as different programs or different functions. In order to achieve higher flexibility, the characteristics of task threads totally upgrade to software classification. Each task runs on a different program; the task thread would not be interrupted for communication with other threads; each task thread is presented as a work group with a work item in OpenCL. FIG. 3 comprises thread 0 301, thread 1 302, thread 2 303 and thread 3 304 corresponding to task 0 to task 3, wherein the threads are connected with a superscale execution channel 306 respectively via four parallel I/O wires 305, meanwhile, the superscale execution channel 306 is also connected with the local memory via a storage bus 307; at this moment, the local memory is divided into four parts, which are the areas used for storing the data corresponding to the four threads (301, 302, 303, 304) above respectively, wherein the areas are the area 308 corresponding to thread 0, the area 309 corresponding to the thread 1, the area 310 corresponding to the thread 2 and the area 311 corresponding to the thread 3 respectively. Each of the threads (301, 302, 303, 304) reads data in the corresponding areas (308, 309, 310, 311) respectively.

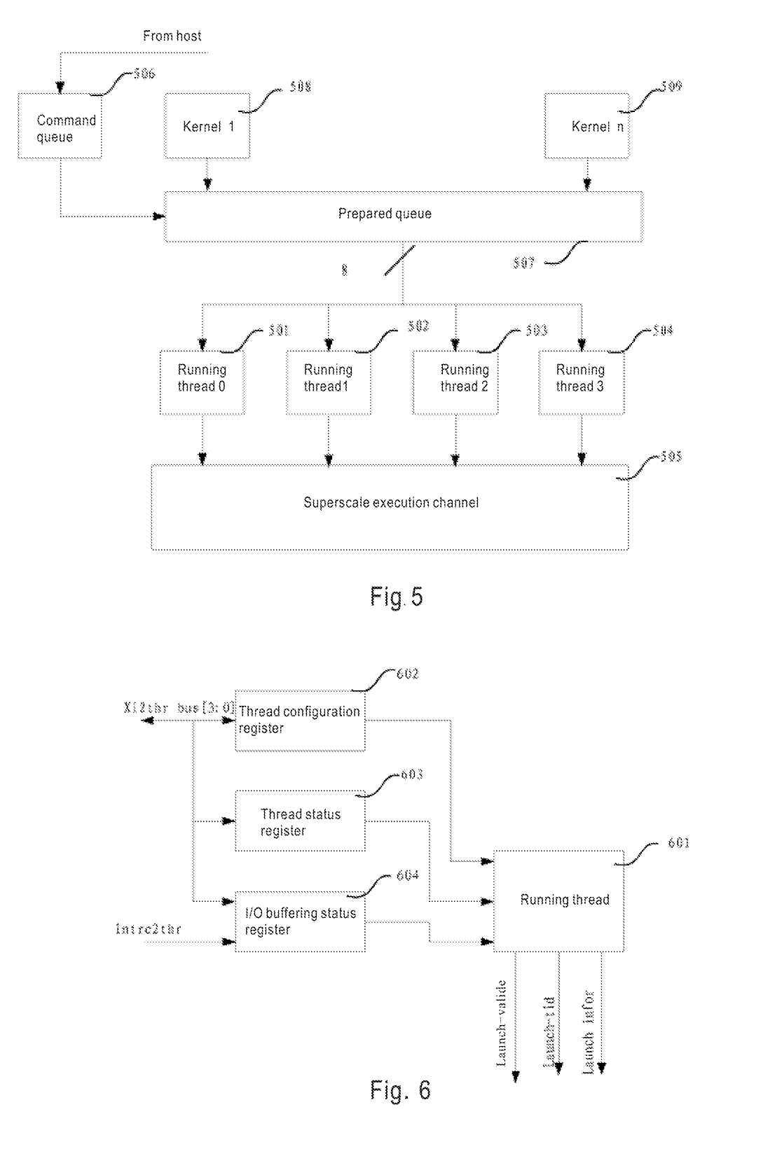

In view of application specific integrated circuit, MVP threads are presented as different function channel layers, which are the design points and key characteristics. Each function layer of the MVP thread is similar to different running kernels, just as the task thread. The greatest feature of the MVP thread is that the MVP thread can activate or shut down itself automatically according to the input data status and the output buffering capability. The capability that the MVP thread automatically activates or shuts down itself enables the thread to remove the completed threads from the currently executing channel and release hardware resource for other activated threads; thus, the load balance capability we expect is provided; in addition, the MVP thread can activate more threads than the running threads and supports at most eight activated threads; the eight threads are dynamically managed, wherein at most four threads can run while the other four activated threads wait idle running time periods. Referring to FIG. 4 and FIG. 5, FIG. 4 shows the relationship between the thread and the local memory in the MVP mode, wherein thread 0 401, thread 1 402, thread 2 403 and thread 3 404 are connected with a superscale execution channel 406 respectively via parallel I/O connection wires 405; meanwhile, the threads (tasks) also are connected separately with the areas (407, 408, 409, 410) allocated to the threads in the local memory; among the areas, through virtual direct memory access (DMA) engine connection, the virtual DMA enables quick transfer of the data between the divided areas when needed; in addition, the divided areas are connected with a bus 411 respectively, and the bus 411 is connected with the superscale execution channel 406 too. FIG. 5 describes the thread condition in the MVP mode in another view. FIG. 5 comprises four running threads, namely, running thread 0 501, running thread 1 502, running thread 2 503 and running thread 3 504, wherein the four threads run on the four ALUs above respectively, and are connected with a superscale execution channel 505 via parallel I/O wires respectively; meanwhile, the four running threads are connected with a prepared thread queue 507 respectively (actually, the four threads are extracted from the thread queue 507); from the description above, it can be known that there are prepared but not running threads in the queue above, and the prepared but not running threads at most can be eight; of course, according to actual application, the threads might be less than eight; wherein the prepared threads can be the same kernel (application, kernel 1 508 to kernel n 509 in FIG. 5) or not; in extreme conditions, the threads might belong to eight different kernels (applications) respectively; of course, it might be other number in actual application; for example, the threads might belong to four applications, while each application might have two threads prepared (in the condition of the same thread priority). The threads in the queue 507 are from an external host through the command queue 509 in FIG. 5.

In addition, if a follow-up thread of a special time-consuming thread in the circular buffering queue has requirement, the same thread (kernel) can be started in multiple running time periods. In this condition, the same kernel can start more threads one time so as to speed up the follow-up data processing in the circular buffer.

The combination of different execution modes of the threads above increases the chance of running four threads concurrently, which is an ideal state and increases the instruction output rate to the greatest extent.

By transferring the best load balance, the interaction between the minimum MVP and the host CPU and the data movement between the MVP and the host memory, the MVP thread has the best cost-performance configuration.

For the computing of resource by fully using hardware in a multi-task or/and multi-data room, load balance is an effective method; the MVP has two ways to manage load balance, wherein one way is to configure four activated threads (in the task thread mode or the MVP thread mode, eight threads are activated) through any available mode (typically, through a common IPA) by using software; the other way is to dynamically update, check and adjust the running threads during running time by using hardware. In the configuration process of software, just as we know that most application characteristic needs to set static task division for special application in initial time; however, the second way requires the hardware to have a capability of dynamic adjustment in different running time. The two ways above enable the MVP to reach maximum instruction output bandwidth in the condition of maximum hardware utilization; however, latency hiding depends on the double-output capability for keeping four-output rate.

The MVP configures four threads by configuring the thread control register using software, wherein each thread comprises a register configuration set and the set includes Starting_PC register, Starting_GM_base register, Starting_LM_base register and Thread_cfg register, in which, the Starting_PC register is used for indicating the start physical location of a task program; the Starting_GM_base register is used for indicating the base point location of the thread local memory for starting a thread; the Starting_LM_base register is used for indicating the base point location (only for MVP thread) of the thread global memory for starting a thread; and the Thread_cfg register is used for configuring threads and further comprises: Running Mode bit, which indicates common when being 0 and indicates preferred when being 1; Thread_Pri bit, which sets the running priority (0 level-7 level) of thread; Thread Types bit, which indicates thread unavailable when being 0, indicates a data thread when being 1, indicates a task thread when being 2 and indicates an MVP thread when being 3.

If a thread is in the data thread or task thread mode, when the thread is activated, the thread enters to the running status in a next period; if the thread is in the MVP mode, the thread buffering and the validity of input data are checked regularly in each period; once prepared, the activated threads enter to the running status; a thread which enters to the running status uploads the value in the Starting_PC register to one of four program counters (PC) of the running channel program, then the thread starts to run. For thread management and configuration parameters, refer to FIG. 6. In FIG. 6, a running thread 601 reads or accepts the values of a thread configuration register 602, a thread status register 603 and an I/O buffer status register 604, and converts the values into three control signals to output, wherein the control signals include: Launch-valid, Launch-tid and Launch infor.

When executing to the instruction EXIT, the thread is completed.

The three threads above can only be disabled by software. The MVP thread can be set to Wait state when the hardware ends the current data set, waiting a next data set of the thread to be prepared or sent to the corresponding local storage area.

The MVP has no internal hardware connection between the data thread and the task thread, except a shared memory and a barrier feature with API definition. Each of the threads is processed as a completely independent hardware. Even so, the MVP provides inter-thread interrupt characteristics; then each thread can be interrupted by any one of other kernels. Inter-thread interrupt is software interrupt which is written into a software interrupt register by the running thread to particularly interrupt a specified kernel, including the kernel of the inter-thread interrupt itself. After such an inter-thread interrupt, the terminal program of the interrupted kernel is called.

Just like a conventional interrupt processing program, if the interrupt in the MVP is enabled and configured, each of the interrupted threads goes to a preset interrupt processing program. If software is enabled, each MVP responds to external interrupt. An interrupt controller processes all interrupts.

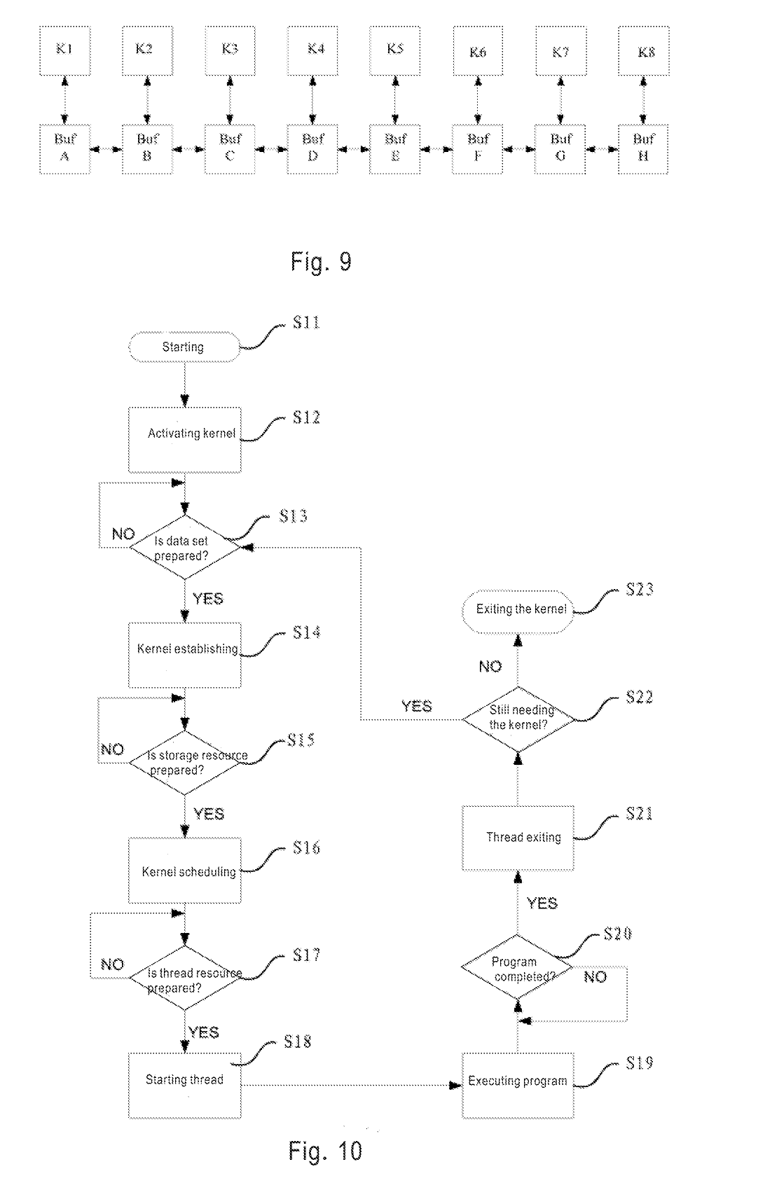

All MVP threads are viewed as a specific integrated circuit channel of hardware; therefore, each interrupt register is used for adjusting the sleep and awaking of a single thread. The thread buffer is used as an inter-thread data channel. The rules of the MVP thread are divided using software, similar to the characteristics of multi-processor in the task parallel computing mode, that is, any data stream passing through all threads is unidirectional so as to avoid the interlocking between any threads, which means that the function with data forward or backward switching is viewed as a kernel which is kept in a single task; therefore, after software initialization configuration is performed, the inter-thread communication fixedly passes through a virtual DMA channel and is automatically processed by hardware during the running time; thus, the communication becomes transparent for software and does not active the interrupt processing program unnecessarily. Referring to FIG. 9, FIG. 9 shows eight kernels (applications, K1 to K8) and the corresponding buffer areas (Buf A to Buf H), wherein the buffer areas are connected via virtual DMA channels for fast data copy.

The MVP has a 64 KB SRAM in the kernel as a thread buffer, wherein the SRAM is configured as 16 areas, each area with 4 KB; the areas are mapped to a fixed space of the local memory by each thread memory. For the data thread, the 64 KB thread buffer is the entire local memory, like a typical SRAM. Since there are at most four work items belonging to the same work group, for example, four threads, the thread processing can be linearly addressed (referring to FIG. 2).

For the task thread, the 64 KB thread buffer can be configured as at most eight different local memory sets, each set corresponding to a thread. (Referring to FIG. 3) the numerical value of each local memory can be adjusted by software configuration.

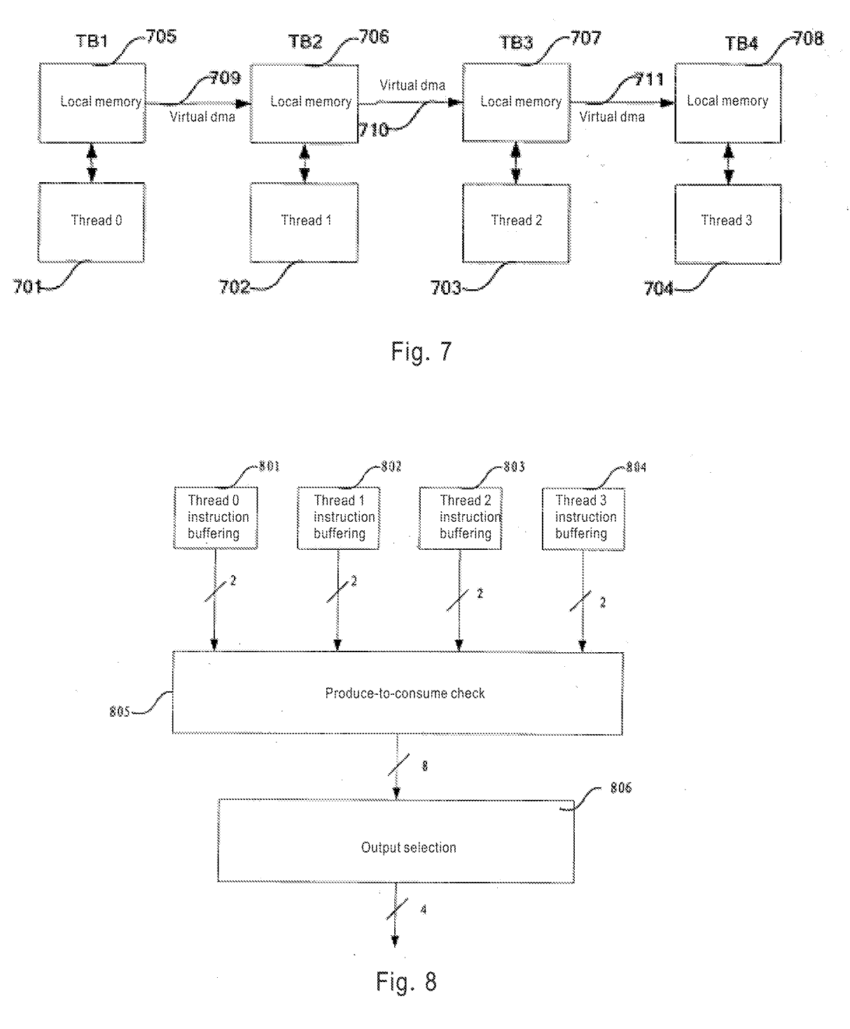

For the MVP thread mode, the configuration of the 64 KB thread buffer has only one mode as shown in FIG. 7. Just like the task thread mode, each MVP thread has a directed thread buffer as the local memory of the kernel; in the condition that four threads are configured as shown in FIG. 7, each thread has a 64 KB/4=16 KB local memory. In addition, the kernel can be viewed as a virtual DMA engine, which can copy the content in the local memory of a thread to the local memory of a next thread entirely and instantaneously, wherein the instantaneous copy of stream data is realized by dynamically changing the virtual physical mapping in the activated thread by the virtual DMA engine. Each thread has its own mapping, and when the execution of the thread is complete, the thread upgrades its own mapping and restarts execution in accordance with the following rules: if the local memory is enabled and is valid (input data arrives), the thread is ready to start; after the thread is complete, the mapping is switched to a next local memory and the local memory of the current mapping is marked to be valid (output data prepares for a next thread); return to the first step.

In FIG. 7, thread 0 701, thread 1 702, thread 2 703 and thread 3 704 are respectively connected with the storages areas (705, 706, 707, 708) which are mapped as the local memories; the storage areas above are connected via virtual DMA connections (709, 710, 711). It is worth mentioning that in FIG. 7 the virtual DMA connections (709, 710, 711) do not exist in hardware; in the embodiment, data transfer in the storage areas is realized by changing the configuration of thread, thus from outside it seems that connections exist, actually, hardware connection does not exist, so are the connections from Buf A to Buf H in FIG. 9.

Note that, when a thread is ready to start, if there is other thread which is ready, the thread might not be started, particularly in the condition of more than four activated threads.

The operation of the thread buffer above is mainly to provide in the MVP thread mode a channel data stream mode which moves the content in the local memory of an earlier thread to the local memory of a latter thread without performing any mode of data copy, so as to save time and electricity.

For the input and output stream data of the thread buffer, the MVP has a separate 32-bit data input and a separate 32-bit data output which are connected to the system bus via external interface buses; therefore, the MVP kernel can transmit data to/from the thread buffer through load/store instruction or virtual DMA engine.

If a specific thread buffer area is activated, it means that the thread buffer area together with the thread is executed and can be used by the thread program. When an external access attempts to write, the access is delayed by out-of-synchronization buffering.

In each period, for a single thread, there are four instructions being fetched. In the common mode, the instruction fetch timeslot is transferred in all running treads in a circular mode, for example, if there are four running threads, each thread fetches instructions every four periods; if there are four running threads and two of them are in a preferred mode which allows two instructions to be output in each period, the interval above is reduced to 2. The value selection of the thread depends on the circular instruction fetch token, the running mode and the status of the instruction fetch buffer.

The MVP is designed to support four threads to run concurrently, wherein at least two threads run concurrently; therefore, instruction is not fetched in each period, thus enough time is reserved for establishing a next PC directed address for any type of unlimited stream programs. Since the design point is four running threads, the MVP has four periods before a next instruction fetch of the same thread, thus three periods are provided for tributary resolution delay. Although addressing seldom exceeds three periods, the MVP has a simple tributary prediction policy for reducing the tributary resolution delay of three periods, wherein the MVP adopts a static always-not-taken policy. In the condition of four running threads, the simple tributary prediction policy does not produce an effect of causing possible errors, because the PC of the thread performs tributary resolution while fetching instructions; therefore, the characteristic is determined by design performance to start or stop, no further design is needed to adapt to different number of running threads.

As shown in FIG. 8, the point that the MVP always outputs four instructions (referring to the output selection 806 in FIG. 8) in each period is an important point. In order to find four prepared instructions from the thread instruction buffer, the MVP checks eight instructions, that is, two instructions of each running thread (801, 802, 803, 804), wherein the instructions are transmitted to the output selection 806 through produce-to-consume 805. Generally, if mismatch does not exist, each running thread outputs an instruction; if mismatch exists, for example, implementation result is waited for a long time or there are not enough running threads, the two checked instructions of each thread detect any ILPs in the same thread, so as to hide paused thread latency and achieve maximum dynamic balance. Besides, in the preferred mode, in order to achieve maximum load balance, two prepared instructions of the thread with higher priority are selected prior to that of the thread with lower priority, which is good for bettering utilizing any ILPs of the thread with higher priority, shortens the operation time of more time-sensitive tasks and enhances the capability which can be applied to any thread mode.

Since the MVP has four LAUs, four MACs and at most four outputs in each period, resource produce-to-consume is set generally, except referring to a fixed function unit; however, similar to a general processor, there exists data produce-to-consume which needs to be cleared before instruction is output. Between any two instructions output in different periods, there might exist long latency produce-to-consume, for example, a producer instruction of long latency specified function unit occupying n periods, or a load instruction at least occupying two periods. In this condition, any consumer instruction is mismatched to know that the produce-to-consume is cleared. In order to keep load balance, more than one instruction needs to be sent out in a period; or in order to hide latency, produce-to-consume check should be performed when the second output instruction is sent out, so as to confirm that no correlation is produced to the first instruction.

Latency hiding is the important characteristic of the MVP. In the MVP instruction implementation channel, there are two conditions of long latency; one is the special function unit and the other is the access to external memory or I/O. In any condition, the requested thread is set to Pause state, and no instruction is output until the long latency operation is complete. During this time, there is one running thread less and other running threads would fill the idle timeslot to utilize extra hardware; now provided that each special function unit is combined with a thread only, if anytime there is more than one thread running on the specified special function unit, resource shortage of the special function unit is not necessarily to be worried; at this moment, one ALU can not implement the load instruction processing alone; if the load instruction loses a buffer, the load instruction can not occupy the channel of the specified ALU, because the ALU is a general execution unit and can be used by other threads freely; thus, for long-latency load access, we adopt a method of instruction cancel to release the channel of ALU. The long-latency load instruction has no need to wait in the channel of ALU like a common processor; contrarily, the long-latency load instruction is resent when the thread runs again from the Pause state.

As mentioned above, the MVP does not perform any tributary prediction, thus no deduction is performed; therefore, the only condition causing the instruction cancel is from load latency pause; for any known buffer loss, at the instruction submission stage of MVP, the Write Back (WB) stage that one instruction can be complete certainly is a data memory access (MEM) stage. If buffer loss has occurred, the occupied load instruction is canceled, thus all instructions upgrade from the MEM stage to the IS stage, that is, the MEM plus execution or address calculation (EX), and the follow-up instructions are canceled too; the threads in the thread instruction buffering would enter to Pause state until they are awaken by a awaking signal, which means that the threads in the thread instruction buffer have to wait until they find the MEM stage; meanwhile, the operation of instruction pointer needs to consider the possibility of any type of instruction cancel.

In the embodiment, the MVP has no universal processor, but is connected with an external CPU via an interface; actually, the external CPU is a coprocessor. In other embodiments, the MVP also can have a universal processor to form a complete work platform, wherein the advantages are that the MVP does not need to be connected with an external CPU, and is independent and convenient to use.

In the embodiment, the processing steps of a kernel are as follows:

S11: starting. In S11, the processing of thread is started in a kernel; in the embodiment, the thread can be one thread or more threads belonging to the same kernel.

S12: activating kernel. In S12, a kernel (application) is activated in the system, wherein the system might comprise a plurality of kernels, not every kernel is running at any time; when the system needs some application to operate, the kernel (application) is activated by writing a particular value of an internal register into the system.

S13: is data set prepared? It is judged whether the data set of the kernel above is prepared, if yes, a next step is executed, otherwise, S13 is repeated.

S14: kernel establishing. In S14, by writing a value of the internal register, for example, the value of each register in the thread configuration mentioned above, the activated kernel is established.

S15: is storage resource prepared? It is judged whether the storage resource corresponding to the kernel is prepared, if yes, a next step is executed, otherwise, S15 is repeated. The storage resource preparation mentioned here includes the enabling of a memory.

S16: kernel scheduling. In S16, the kernel above is scheduled, for example, storage area corresponding to the thread is allocated, data needed by the thread is imported.

S17: is thread resource prepared? It is judged whether the resource related to thread is prepared, if yes, a next step is executed, otherwise, the former steps are repeated, waiting the finish of the preparation. The resource includes the enabling and validity (i.e. data is input) of storage area, the configuration and marking of the local memory.

S18: starting thread. In S18, the thread is started and starts to run.

S19: executing program. It is all known that thread is a set of multiple codes; in S19, the codes are executed one by one according to the order of the codes.

S20: program completed? It is judged whether the execution of the programs in the thread is complete, if yes, a next step is executed, otherwise, S20 is repeated, waiting the completion of the execution of programs in the thread.

S21: thread exiting. In S21, since the thread is complete, the thread exits, and the resource occupied by the thread is released.

S22: still needing the kernel? It is judged whether the kernel has other threads which need to be processed or whether there is data being input belonging to the kernel, if yes, it is considered that the kernel is needed, the kernel can be kept, it is jumped to S13 to continue executing, otherwise, it is considered that the kernel is not needed; a next step is executed.

S23: exiting the kernel. The kernel is exited and the resource occupied is released; a processing flow of the kernel is ended.

The method above describes the processing of a kernel, it is worth mentioning that in the embodiment the processing method above at the same time can concurrently process four threads, that is, four sets of the steps above can be performed at the same time; wherein the threads can belong to different kernels respectively, also can be four threads belonging to the same kernel.

The embodiment above only expresses several implementations of the present invention; the description is specific and detailed, however, it can not be interpreted as a limit to the scope of the present invention. It should be noted that for the ordinary technicians of the field various modifications and improvements can be made without departing from the idea of the present invention; these modifications and improvements all belong to the protection scope of the present invention; therefore, the protection scope of the invention is based on the claims attached hereto.

What is claimed is:

1. A parallel processor, comprising:
a plurality of thread processing engines for processing threads distributed to the thread processing engines, the plurality of thread processing engines being connected in parallel; and
a thread management unit for obtaining, judging the statuses of the plurality of thread processing engines, and distributing the threads in a waiting queue among the plurality of thread processing engines.

2. The parallel processor according to claim 1, further comprising an internal storage system for data and thread buffering and instruction buffering, and a register for storing various statuses of the parallel processor.

3. The parallel processor according to claim 2, wherein the internal storage system comprises a data and thread buffering unit for buffering the threads and data, and an instruction buffering unit for buffering instructions.

4. The parallel processor according to claim 1, wherein the plurality of thread processing engines comprises four parallel independent arithmetic logic units (ALU) and multiply-add units (MAC) one-to-one corresponding to the ALUs.

5. The parallel processor according to claim 1, wherein the thread manager further comprises a thread control register for configuring threads; the thread control register comprises an initial program pointer register for indicating the start physical address of a task program, a local storage area start base point register for indicating the start address of the thread local storage area of a thread, a global storage area start base point register for indicating the start address of the thread global storage area and a thread configuration register for setting the priority and the running mode of the thread.

6. The parallel processor according to claim 1, wherein the thread manager determines, according to the input data status of a thread and the output buffering capability of the thread, whether to activate the thread; the number of activated threads is greater than the number of the threads running concurrently.

7. The parallel processor according to claim 6, wherein an activated thread runs on different thread processing engines under the control of the thread manager during different time periods.

8. The parallel processor according to claim 7, wherein the thread manager changes the thread processing engine on which the activated thread runs by changing the configuration of the thread processing engine; the configuration includes the value of the initial program pointer register.

9. The parallel processor according to claim 1, further comprising a thread interrupt unit for interrupting threads by writing data into an interrupt register, wherein the thread interrupt unit controls the interrupt of the threads in the kernel or other kernels when the control bit of the interrupt register is set.

10. The parallel processor according to claim 2, wherein the thread processing engine, the thread manager and the internal storage system are connected with an external or in-built universal processor and an external storage system via a system bus interface.

11. A method for concurrently processing threads in the parallel processor, comprising the following steps of:
A) configuring a plurality of thread processing engines in the parallel processor;
B) according to the status of the thread processing engine and the status of the to-be-processed thread queue, sending the threads in the to-be-processed thread queue to the thread processing engine;
C) processing the entered threads and enabling them to run by the thread processing engine.

12. The method according to claim 11, wherein the Step A) further comprises a step of:
A1) judging the type of the to-be-processed thread, configuring the thread processing engine according to the thread type and configuring the local storage area corresponding to the engine.

13. The method according to claim 12, wherein the to-be-processed thread mode includes data parallel mode, task parallel mode and parallel multi-thread virtual pipelined stream (MVP) mode.

14. The method according to claim 11, wherein the Step C) further comprises the steps of:
C1) fetching the instruction of the running thread;
C2) compiling and executing the instruction of the thread.

15. The method according to claim 14, wherein in the Step C1), the instructions of the thread executed by a thread processing engine are acquired in each period; the plurality of parallel thread processing engines acquires in turn the instructions corresponding to the executed thread.

16. The method according to claim 11, wherein when the running thread mode is parallel MVP mode, the Step C) further comprises a step of: when receiving a software or external interrupt request of a thread, interrupting the thread and executing the preset interrupt program of the thread.

17. The method according to claim 11, wherein when the running thread mode is parallel MVP mode, the Step C) further comprises a step of: when any running thread needs to wait a long time, releasing the thread processing engine resource occupied by the thread and allocating the resource to other running threads.

18. The method according to claim 11, wherein when the running thread mode is parallel MVP mode, the Step C) further comprises a step of: when the execution of any running thread completes, releasing the thread processing engine resource occupied by the thread, activating a thread in the to-be-processed thread queue and sending the thread to the thread processing engine.

19. The method according to claim 16, 17 or 18, wherein the threads processed by the thread processing engine are converted by changing the configuration of the thread processing engine; the configuration of the thread processing engine includes the location of the local storage area corresponding to the thread processing engine.
